(19) United States
(12) Patent Application Publication
(10) Pub. No.: US 2011/0252757 A1
(43) Pub. Date: Oct. 20, 2011

(54) HELICAL STRAPPING METHOD FOR HIGH TEMP PLEATED FILTERS

(75) Inventors: Karmin Lorraine Olson, Kansas City, MO (US); Jason Mei, Overland Park, KS (US)

(73) Assignee: BHA Group, Inc., Kansas City, MO (US)

(21) Appl. No.: 12/763,264

(22) Filed: Apr. 20, 2010

(51) Int. Cl. B01D 46/52

(52) U.S. Cl. 55/486

(57) ABSTRACT

A filter cartridge that includes a filter media. The media is pleated and the pleats are arranged into a tube about an axis with a first pleat proximate a last pleat. The filter cartridge includes a strap that has first and second end portions and that extends at least one revolution around the pleated media tube in a helix such that the first and second end portions of the strap are axially displaced from each other. The first and last pleats of the media are attached to each other and the first and second end portions of the strap are attached to the media. The filter cartridge may be made by an associated method. In one specific example, a stitching attaches the strap to the media.

### BACKGROUND OF THE INVENTION

1. Field of the Invention

The present invention relates generally to gaseous filters, and more particularly, to pleated gaseous filters that can operate in baghouses in various environments.

2. Discussion of the Prior Art

Gaseous filters, for filtering a gas such as air, are known and used in many different applications, including baghouses. Each baghouse may be provided with one or more gaseous filters for filtering dirty gas in various environments. Current technology filters include pleated filter media that have circular reinforcing straps secured to the pleated media via adhesive. Often, these types of filters are used in a high temperature environment and/or an environment that includes chemical(s) that may degrade the adhesive. Improvements in pleated filter technologies to avoid degradation of the adhesive securing circular reinforcing straps would be beneficial.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a filter cartridge that includes a filter media. The media is pleated and the pleats are arranged into a tube about an axis with a first pleat proximate a last pleat. The filter cartridge includes a strap that has first and second end portions and that extends at least one revolution around the pleated media tube in a helix such that the first and second end portions of the strap are axially displaced from each other. The filter cartridge includes means for attaching the first and last pleats of the media to each other and the first and second end portions of the strap to the media.

In accordance with another aspect, the present invention provides a method of providing a filter cartridge. A pleated filter media provided, with the filter media having first and last pleats. The media is arranged into a tube about an axis with a first pleat proximate a last pleat. A strap is provided, with the strap having first and second end portions. The strap is extended at least one revolution around the pleated media tube in a helix, with the first and second end portions axially displaced from each other. The first and last pleats are attached to each other and the first and second end portions of the strap to the media.

In accordance with another aspect, the present invention provides a filter cartridge. The filter cartridge includes a filter media, with the media being pleated and the pleats being arranged into a tube. The filter cartridge includes a strap extending in a spiral about the filter media. The filter cartridge includes a stitching to attach the strap to the media.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a partially schematic view of an example baghouse having a plurality of example filter cartridges that incorporate at least one aspect of the present invention;

FIG. 2 is a side view of one of the filter cartridges shown in FIG. 1 as the filter cartridge is seated within the baghouse and shows details of an extending strap and stitching in accordance with an aspect of the present invention;

FIG. 3 is an enlarged, perspective view of the filter cartridge of FIG. 2 and shows details of the strap and stitching in accordance with an aspect of the present invention;

FIG. 4 is an enlarged section view taken along line 4-4 in FIG. 2 and shows details of the strap and stitching in accordance with an aspect of the present invention; and

FIG. 5 is an enlarged view of a portion of the filter cartridge of FIG. 2 and shows details of the relationship of an end of helical reinforcing strap to pleated media of the filter cartridge.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

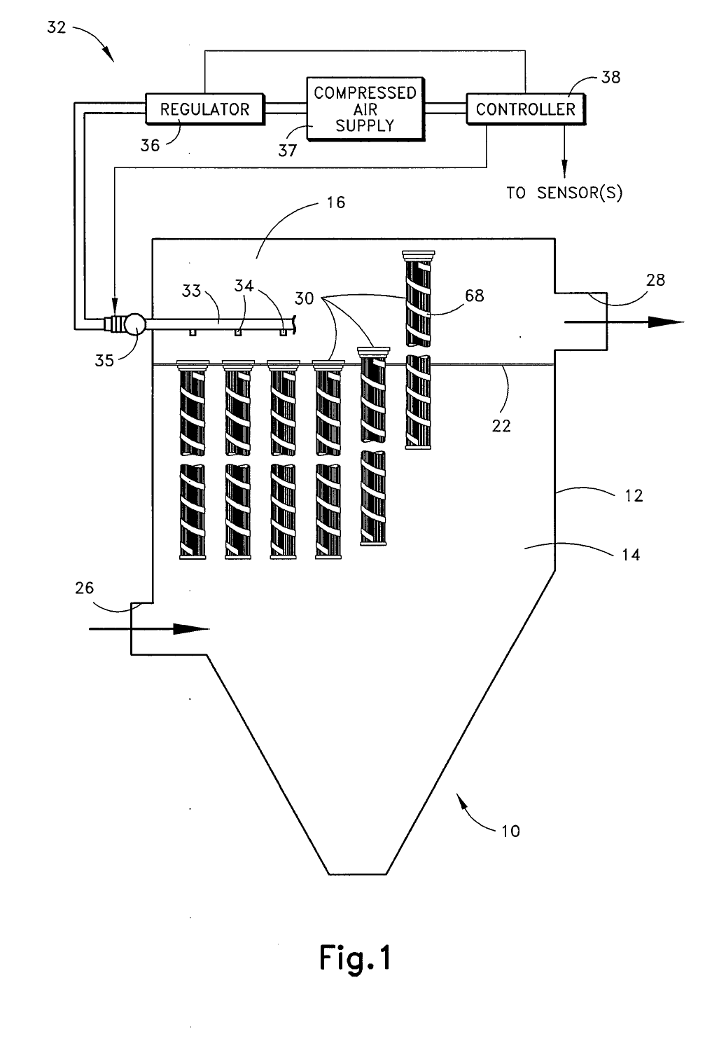

FIG. 1 schematically shows an example interior of a baghouse 10 as an environment within which the present invention may be utilized. It is to be appreciated that in one example the baghouse 10 is for filtering air. However, it is to be further appreciated that filtration associated with the present invention may be for other gaseous fluids other than air. Herein the example is described for use with air filtration. However, it is to be appreciated that the present invention is not limited to use only for filtering air.

The baghouse 10 may be defined by an enclosed housing 12 and can be divided into two sections, a dirty air plenum 14 and a clean air plenum 16. The dirty air plenum 14 and the clean air plenum 16 may be placed in fluid communication with each other and separated by a tubesheet 22, which is a wall, a divider, or the like. The dirty air plenum 14 is in fluid communication with a dirty air inlet port 26 allowing unfiltered air to enter the baghouse 10 through the dirty air inlet port. The clean air plenum 16 is in fluid communication with a clean air outlet port 28 allowing filtered air to exit the baghouse 10 through the clean air outlet port. The dirty air plenum 14 and the clean air plenum 16 may be arranged in fluid communication via one or more circular openings formed in the tubesheet 22. Each opening may be sized to accept and hold a filter cartridge 30. The tubesheet 22 prevents the passage of air through the tubesheet. Instead, air may pass from the dirty air plenum 14 to the clean air plenum 16 through the filter cartridges 30. It is to be appreciated that the baghouse 10 may be varied and the presented example is not to be taken as a limitation upon the present invention.

In the shown example of FIG. 1, six filter cartridges 30 are shown. However, the baghouse may include any number (i.e., one or more) of filter cartridges 30. The filter cartridges 30 are generally elongate may be arranged parallel (e.g., axes of elongation) to each other in a substantially vertical manner. It is to be appreciated that the filter cartridges may have dimensions (e.g., diameter and length) that differ dependant upon desired configurations.

The filter cartridges 30 are capable of filtering gas (e.g., air) to remove a variety of dry elements. For instance, the filter cartridges 30 may be used, but are not so limited, to filter hot gas(es) with temperature of approximately 500° F. and with temperature surges up to approximately 700° F. In addition, the filter cartridges 30 may be used in applications at the stated temperatures in environments that may have gas streams and/or have dust which are acidic or alkaline. These applications may include, but are not limited to, carbon black processing, titanium dioxide processing, etc.

It is to be appreciated that filtered material may accumulate on the filter cartridges 30. As such, an arrangement 32 for cleaning the filter cartridges 30 may be associated with the baghouse 10. The arrangement 32 may have a varied form, configuration, construction, etc. and the shown arrangement is only an example.

Turning to the shown example, the cleaning arrangement 32 provides a cleaning action via application of a reverse-flow, clean air pulse to each filter cartridge 30. A cleaning blow pipe arrangement 33 is configured and positioned such that the nozzles 34 or the like direct a pulses into the filter cartridges 30. The blow pipe arrangement 33 is connected, via a distribution manifold 35 and a regulator 36, to a supply of compressed air 37. The regulator 37 and the manifold 35 are operatively connected to a controller 38. In turn the controller is operatively connected to one or more sensors. It is to be appreciated that the reverse-flow pulse applied to the filter cartridges 30 may apply force to the cartridges.

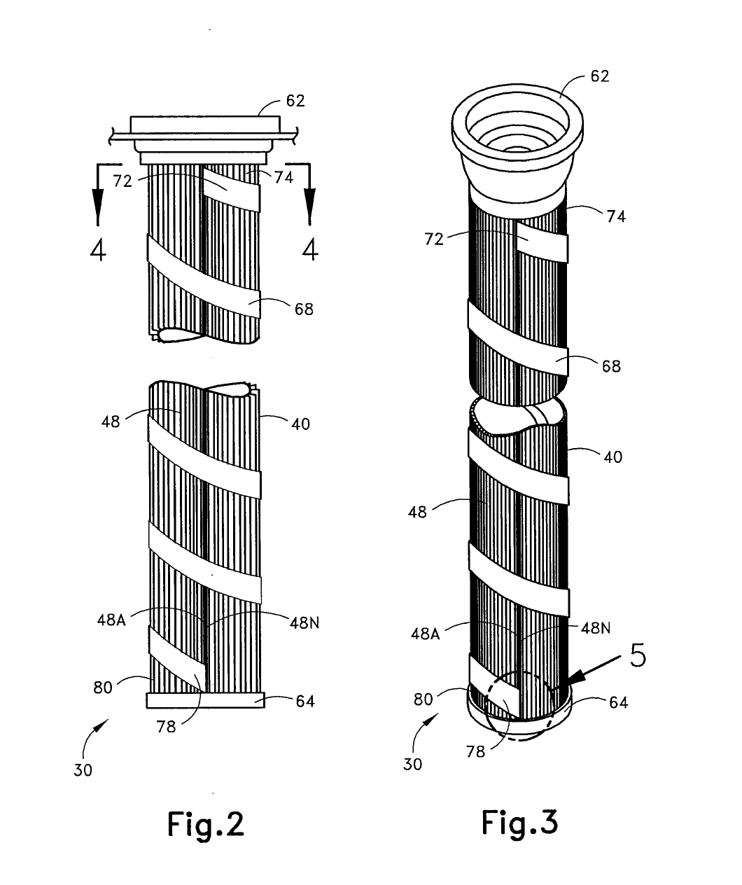

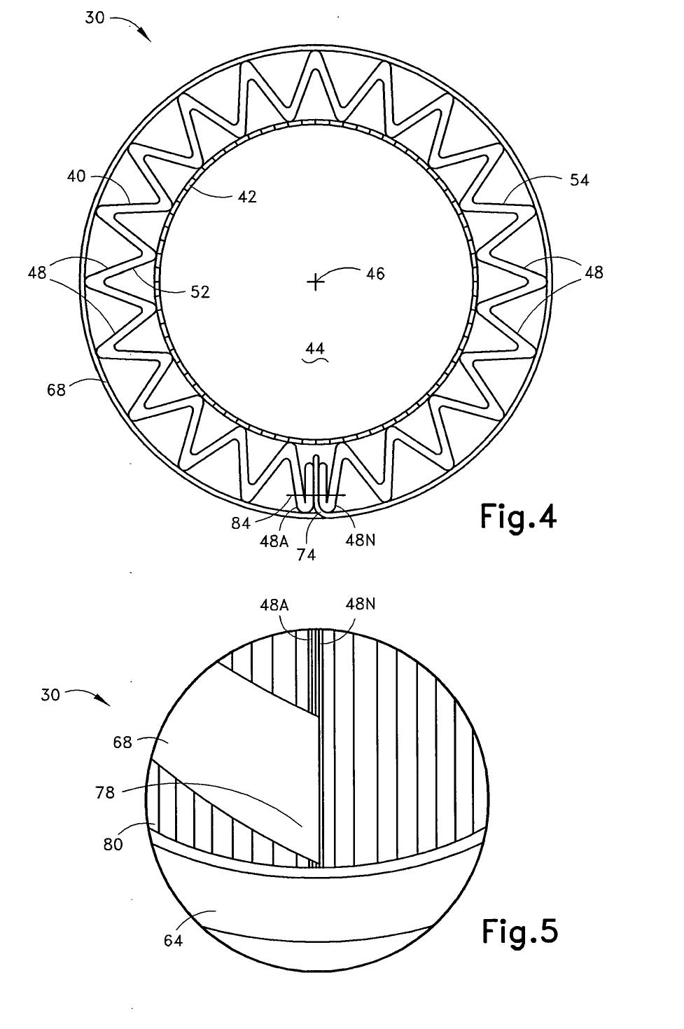

As shown in FIGS. 2-5, a representative example filter cartridge 30 includes a filter media 40. In the shown example, the filter media 40 is arranged around an inner core 42 (FIG. 4). The inner core 42 defines an elongated central passageway 44 formed within the filter cartridge 30. The elongation is along a center axis 46. The inner core 42 may be made of a number of different metal materials, such as steel, titanium, or the like, and may be sufficiently stiff to provide some support to the filter cartridge 30. The core 42 includes openings on its surface to allow for the passage of air through the core. For instance, the core 42 may include a plurality of perforations, apertures, holes, etc. to allow air to pass from the exterior of the core to the central passageway 44.

In the shown example (FIGS. 2-4), the filter media 40 is arranged as a tube to encircle the inner core 42 and has a plurality of pleats 48. The pleats 48 are elongated parallel to the axis and extent in a zig-zag pattern toward and way from the center axis 46. The filter media 40 has an inner surface 52 and an outer surface 54. In the shown embodiment, a portion of the inner surface 52 engages and/or is adjacent to the inner core 42 at the radially inward extent of the pleats 48. The inner core 42 helps to maintain the cylindrical shape of the filter cartridge 30. Also, the inner core 42 helps to prevent inward displacement of the filter media 40 during the filtering process. It is possible that during the filtering process a pressure differential would urge the filter media 40 radially inward.

The filter media 40 may have a varied construction/configuration and as such a specific construction/configuration of the filter media may not be a specific limitation upon the present invention. In one example, the filter media 40 includes an expanded polytetrafluoroethylene (ePTFE) membrane laminated to a substrate on the upstream side of the media. In other examples the filter material may include other filtering material, such as fiberglass. Also, in some examples, the filter media 40 may have multiple layers and may have different materials for different layers. Still further, the filter media 40 may include structural support aspects, such as stiffening agent(s) and/or a wire mesh scrim or the like. Such stiffening agent(s) or scrim permit air flow for the passage of air to allow air to pass in the direction from a dirty side (exterior) to a clean side (interior) of the filter media 40 and also provides rigidity to the filter media 40. Such rigidity permits the filter media 40 to be formed into a shape and to retain the formed shape. In particular, the filter media 40 may be formed and retained in a shaped that is pleated.

The filter cartridge 30 may also include one or more end caps 62, 64 (upper and lower as viewed in the FIGS. 1-3) at either or both ends of the filter cartridge. The end caps 62, 64 may act to allow and/or prevent the passage of air through an end of the filter cartridge and ensure that air flow is only through the filter media 40 to aid the filtering process. Also, the end caps 62, 64 provide structure to mount and support the filter media 40. Herein the end caps 62, 64 are referred to as upper and lower merely for convenience and not as an indication of a required orientation. It should be appreciated that the filter cartridges 30 may be oriented differently. For example, the filter cartridges may be utilized horizontally or inverted from the orientation shown in FIGS. 1-3).

In the shown example, the lower end cap 64 provides for complete blocking, whereas the upper end cap 62 provides for perimeter sealing and is open at the center to permit air flow out from the central passageway 44. The end caps 62, 64 may include rigid members, seals, etc. as will be appreciated by the person of ordinary skill in the art. The cylindrical filter media 40 and the associated structures (e.g., inner core 42) are secured to the end caps 62, 64. In one specific example the cylindrical filter media 40 and the associated structures (e.g., inner core 42) are potted with an adhesive material to the end caps 62, 64. The adhesive can be a high temperature adhesive and not adversely affected by the temperatures encountered during use of the filter cartridge 30. The end caps 62, 64 may include annular recesses for receiving axial ends of the cylindrical filter media 40 and the associated structures (e.g., inner core 42).

In accordance with an aspect of the present invention, a strap 68 extends around the filter media 40. The strap 68 may help retain the filter media 40 in place around the inner core 42. As part of this function, the strap 68 helps supporting retention to the filter media 40 during a reverse pulse cleaning. In one specific example, the strap 68 that extends as a helix spiral around the filter media 40. Specifically, one end portion 72 of the strap 68 is located adjacent to an upper end portion 74 of the filter media 40, the strap 68 extends in a downward spiral that revolves around the filter media with at least one revolution around the filter media, and a second end portion 78 is located adjacent to a lower end portion 80 of the filter media. Thus, the first and second end portions 72 and 78 are axially displaced from each other. Also, in the shown example, the first and second end portions 72 and 78 are not connected to each other (e.g., not connected to form a circle). The strap 68 may extend to have any number of revolutions around the filter media 40. In the shown example of the Figures, at least four revolutions of the strap 68 are shown (additional revolutions could be present dependent upon length of missing tear-away section shown in the Figures).

In one example the strap 68 is a woven ribbon of material. In some examples, the woven material may include woven inorganic material such as ceramic or glass fibers. However, it is to be appreciated that the strap 68 may have a different construction/configuration. For example, the strap 68 may include a number of materials with a high tensile strength, including an extruded polymer, woven polyester, metal, high temperature fabric, etc. In one example, the strap 68 is tolerant of temperatures up to the approximately 700° F. temperature surges that are imposed by the hot gas while still providing an acceptable level of strength. However, it is contemplated that in a specific example the strap 68 is tolerant of temperatures up to 1800° F. while still providing an acceptable level of strength. The strap 68 has a relatively small surface area as compared to the surface are of the filter media 40. In one example, the surface area of the strap 68 is only a small percentage in comparison to the filter media (e.g., certainly much less than 50%). Moreover, the strap 68 is located at a radially outer portion of the pleats 48 of the filter media 40. As such, the strap does not significantly interfere with the filtering function of the filter media 40.

It is to be appreciated that the filter media 40 in the shown embodiment is initially formed as a flat sheet, crimped to form the pleats 48, and then formed (e.g., rolled) into a tubular, cylindrical shape. As such, two ends of the filter media 40 must be joined together to form the tubular, cylindrical shape. Since the filter media 40 is pleated, the two ends can be referred to as first and last pleats (e.g., 48A and 48N, with N being the last pleat number). Such first and last pleats 48A, 48N extend vertically within the views of FIGS. 2 and 3. The first and last pleats 48A, 48N (i.e., media ends) are attached together. Within the shown example, the first and last pleats (i.e., media ends) are attached to each other via an attachment means 84. In the shown example the attachment means 84 is a sewing stitching 84 (schematically shown in FIG. 4) extending through the first and last pleats 48A, 48N. The stitching 84 secures the first and last pleats 48A, 48N together and helps retains the tubular, cylindrical shape of the pleated filter media 40. Thus, the stitching 84 is an example of structure that is means for attaching the first and last pleats 48A, 48N to each other. In one example the stitching 84 extends the length of the first and last pleats 48A, 48N (i.e., the axial length of the pleated material). In one example, the stitching 84 may be via a high-temperature thread or filament, and may be of material identical or similar to the strap 68. As another example, the stitching 84 may include a series of metal or similar staples. Also, it is possible that an adhesive may be used as an alternative or a supplement to the stitching 84. Such other possibilities are other examples of structure that is means for attaching the first and last pleats 48A, 48N to each other.

In accordance with one aspect of the present invention, end portions 72, 78 of the strap 68 are placed between the first and last pleats 48A, 48N and the stitching 84 secures the strap to the filter media. An example of this positioning is seen in FIGS. 4 and 5. Specifically, FIG. 4 shows the first end portion 72 of the strap 68 located between the first and last pleats 48A, 48N and with the stitching 84 (shown schematically) extending through the first and last pleats and the end portion 72 of the strap 68. FIG. 5 shows the second end portion 78 of the strap 68 extend between the first and last pleats 48A, 48N. The first and second ends 72 and 78 of the strap 68 thus are turned radially inward between the first and last pleats 48A, 48N. The stitching 84 is an example of structure that is means for attaching for the strap 68 to the filter media 40.

As previously indicated, the stitching 84 extends such that the stitching 84 extending through the first and last pleats 48A, 48N and the end portions 72, 78 of the strap 68. In one embodiment (e.g., the shown example), each end portion 72, 78 of the strap 68 is between the first and last pleats 48A, 48N in a sandwich arrangement. However, it is contemplated that the end portions 72, 78 could engage the first and last pleats 48A, 48N differently. For example, the first and last pleats 48A, 48N could engage each other at the strap end location without the strap end (e.g., 72) being sandwiched there between. The strap end (e.g., 72) could thus be stitched (or otherwise secured) to one side (i.e., an outside location) of the first and last pleats 48A, 48N. Again, the stitching 84 in such a configuration of an example of structure that is means for attaching for the strap 68 to the filter media 40. Of course, if there is additional/alternative structure (e.g., adhesive staples or the like) such additional structure is part of the example of structure that is means for attaching for the strap 68 to the filter media 40. Still further, if the filter media 40 is somehow configured differently (e.g., not formed with first and last pleats 48A, 48N that are joined together), the strap 68 may still be joined to the filter media 40 by stitching or other means for attaching.

In accordance with another possible aspect of the present invention, the strap end(s) 72, 74 may be attached with the filter media 40 to the respective end cap(s) 62, 64. In one specific example, the strap end portions 72, 74 and the end portions 74, 80 of the filter media 40 are potted to the respective end cap(s) 62, 64 with an adhesive. As such, the strap end(s) 72, 74 are structurally connected to the respective end cap(s) 62, 64. Such additional structural connection is an example of structure that is means for attaching for end portions 74, 80 of the filter media 40 and/or the strap 68 to the respective end cap(s) 62, 64.

It is to be appreciated that the amount of overlap of the strap end(s) 74, 78 (a) at the first and last pleats 48A, 48N and/or (b) the end cap(s) 62, 64 (e.g., potting) may be varied. The amount of overlap as shown in the FIG. 4 is merely an example.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A filter cartridge including:
a filter media, the media being pleated and the pleats being arranged into a tube about an axis with a first pleat proximate a last pleat;
a strap having first and second end portions and extending at least one revolution around the pleated media tube in a helix, with the first and second end portions axially displaced from each other; and
the first and last pleats of the media attached to each other and the first and second end portions of the strap attached to the media.

2. A filter cartridge as set forth in claim 1, wherein the attachment of the first and last pleats to each other and the first and second end portions of the strap to the media includes stitching that extends through the first and last pleats and the first and second end portions of the strap.

3. A filter cartridge as set forth in claim 1, wherein the strap is a woven inorganic material.

4. A filter cartridge as set forth in claim 3, wherein the inorganic material includes at least one of ceramic or glass fibers.

5. A filter cartridge as set forth in claim 1, wherein the strap includes at least one of extruded polymer, woven polyester, metal and high temperature fabric.

6. A filter cartridge as set forth in claim 1, wherein the strap is tolerant of temperatures up to approximately 700° F.

7. A filter cartridge as set forth in claim 1, wherein the strap extends to have multiple revolutions around the pleated media tube in the helix.

8. A filter cartridge as set forth in claim 1, wherein the strap and the media are sized relative to each other such that the strap covers less than 50% of the media.

9. A filter cartridge as set forth in claim 1, wherein first and second ends of the strap extend radially inward between the first and last pleats.

10. A filter cartridge as set forth in claim 1 further including at least one end cap with the filter media secured to the end cap.

11. A filter cartridge as set forth in claim 10 wherein the filter media is potted to the end cap with a respective end portion of the strap being located thereat.

12. A method of providing a filter cartridge, the method including:
providing a pleated filter media, with the filter media having first and last pleats;
arranging the media into a tube about an axis with a first pleat proximate a last pleat;
providing a strap with first and second end portions;
extending the strap at least one revolution around the pleated media tube in a helix, with the first and second end portions axially displaced from each other; and
attaching the first and last pleats to each other and the first and second end portions of the strap to the media.

13. A method as set forth in claim 12, wherein the step of attaching the first and last pleats to each other and the first and second end portions of the strap to the media includes stitching to extend through the first and last pleats and the first and second end portions of the strap.

14. A method as set forth in claim 12, wherein the step of providing a strap includes providing the strap to include a woven inorganic material.

15. A method as set forth in claim 12, wherein the step of providing a strap includes providing the strap to include at least one of ceramic or glass fibers.

16. A method as set forth in claim 12, wherein the step of providing a strap includes providing the strap to include at least one of extruded polymer, woven polyester, metal and high temperature fabric.

17. A method as set forth in claim 12, wherein the step of attaching the first and last pleats to each other and the first and second end portions of the strap to the media includes positioning the first and second ends of the strap extend radially inward between the first and last pleats.

18. A method as set forth in claim 12, further including the steps of providing at least one end cap, and securing the filter media to the end cap by potting a respective end portion of the filter media to the end cap with the strap being located thereat.

19. A filter cartridge including:
a filter media, the media being pleated and the pleats being arranged into a tube;
a strap extending in a spiral about the filter media; and
a stitching to attach the strap to the media.

20. A filter cartridge as set forth in claim 19, wherein the filter media has ends that are also secured together by the stitching.
